(19) United States
(12) Patent Application Publication
(10) Pub. No.: US 2026/0011317 A1
(43) Pub. Date: Jan. 8, 2026

(54) SYSTEM AND METHOD FOR CONFIGURING AND USING A GENERATIVE ARTIFICIAL INTELLIGENCE SYSTEM

(71) Applicant: Futureverse IP Limited, Auckland (NZ)

(72) Inventors: Yijun Wang, Auckland (NZ); Boyu Chen, Sydney (AU); Peike Li, Sydney (AU); Yao Yao, Shenzhen (CN); Thomas Sidney Smith, JR., Palm Beach, FL (US); Aaron McDonald, Auckland (NZ)

(21) Appl. No.: 18/764,610

(22) Filed: Jul. 5, 2024

(51) Int. Cl. G10H 1/00; G11B 27/031

(52) U.S. Cl. CPC G10H 1/0025; G11B 27/031

(57) ABSTRACT

Generative adversarial networks (GANs) provide a way to learn deep representations without extensively annotated training data. They achieve this through deriving backpropagation signals through a competitive process involving a pair of networks. The representations that can be learned by GANs may be used in a variety of applications, including image synthesis, semantic image editing, style transfer, image super-resolution and classification. The aim of this review paper is to provide an overview of GANs for the signal processing community, drawing on familiar analogies and concepts where possible. In addition to identifying different methods for training and constructing GANs, we also point to remaining challenges in their theory and application.

Index Terms—neural networks, unsupervised learning, semi-supervised learning.

### FIELD OF INVENTION

The present disclosure generally relates to the field of generative artificial intelligence (AI) and more specifically, to systems and methods for automatically generating content based on human preference learning.

### BACKGROUND

Artificial intelligence (AI) has been increasingly utilized in various fields. “Generative AI” refers to AI systems and methods that create new content, such as audio content (music, voices . . . ), pictures, videos, and the like. AI audio generation involves the use of AI models to create audio content, which can range from a simulated voice to simple melodies to complex symphonies. These models are typically trained on large datasets of audio content to learn the underlying patterns and structures that define different genres, styles, moods, and other potential aspects of the generated audio content.

One common approach in AI music generation is the use of “text-to-music generation models”. These models take textual prompts as input and generate music as output. The textual prompts can include descriptions of the desired music, such as its genre, mood, or even specific musical elements like, lyrical subject matter, rhythm and melody. The models then interpret these prompts and generate music that aligns with the given descriptions. For example, a user may enter a prompt such as “generate a 12 bar blues song with 50 beats per minute featuring a saxophone.”

Deep learning techniques, including autoregressive (AR) and non-autoregressive (NAR) methods, are often employed in the neural network layers of these models. AR methods generate sequences where each element is dependent on the previous elements, while NAR methods generate sequences where each element is generated independently. These methods can be used individually or in combination to enhance the quality and diversity of the generated music.

A notable advancement in the field is the development of the JEN-1 series model, which is a sophisticated AI model designed for music generation. The JEN-1 series model incorporates audio autoencoders and audio latent diffusion models to produce high-quality music content. Audio autoencoders are used to learn efficient representations of music, capturing the essence of various musical elements and structures. Audio latent diffusion models, on the other hand, are employed to generate new music content by denoising from a random Gaussian noise in the audio latent space, allowing for the creation of novel compositions that maintain the characteristics of the training data.

AI music generation remains a complex task due to the inherent complexity and diversity of music. It requires capturing, in an AI model, concepts of music theory, creativity, and the ability to reproduce the subtle nuances that define different styles and genres of music. Furthermore, the generated music is desired to be both technically sound and aesthetically pleasing to listeners.

### SUMMARY

According to disclosed implementations, a system for generating content, such as music, using artificial intelligence is provided. The system includes a generative AI base model for generating content based on one or more prompts (such as text prompts). The generative AI base model is pretrained using an annotated data set comprising prompt-content pairs. The base model may include a neural network that effects both autoregressive (AR) and non-autoregressive (NAR) methods in layers of the neural network.

The system also includes a deep learning rating model configured to determine a rating of the quality of content generated by the generative AI base model and to conduct filtering of the content based on the rating. Furthermore, the system includes a user interface for users to edit specific content generated by the generative AI model and conduct a calibration corresponding to the specific content to yield calibrated prompts. The calibrated prompt-audio pairs can be used to augment the training data for the generative AI base model.

The generative AI base model can be a text-to-music generation model, where the generated content is music content. The training data for the rating model may consist of music data paired with rankings, the rankings being provided by human experts, such as musicians. The rankings can be structured into annotated data sets comprising audio-rating pairs. Each pair consists of a music sample and its corresponding rating assigned by the musician based on the established criteria for aesthetic evaluation. These data sets serve as training inputs for the rating model, allowing it to learn patterns and preferences indicative of high-quality music.

The filtering may comprise marking audio clips exceeding a predetermined rating threshold for subsequent fine-tuning of the generative AI base model. The rating model can be trained to evaluate the aesthetics of music based on various criteria, including but not limited to:
Melodic coherence and complexity
Harmonic richness and progression
Rhythmic patterns and dynamics
Emotional expression and engagement
Alignment with the given prompt
Overall composition structure and originality
   These criteria can be derived from expert assessments and user preferences, providing a comprehensive framework for assessing music quality.

The base model may include a JEN-1 series model. The JEN-1 series model may comprise audio autoencoders, including an audio encoder configured to compress the audio to a latent space embedding (i.e., a vector data representation of the audio) and a corresponding audio decoder for reconstructing the latent embedding to the original audio. The base model may also include audio latent diffusion models. The audio encoder transforms raw audio waveforms into compact, meaningful representations/vectors (latent embeddings) suitable for processing by the audio latent diffusion model. These latent embeddings capture essential characteristics of the audio content while reducing dimensionality, enabling efficient training. One known Python library for creating audio embeddings is Openl3. Known algorithms for creating audio embeddings include Mel-frequency cepstral coefficients (MFCCs), Convolutional Neural Networks (CNNs), Pretrained Audio Neural Networks (PANNs), Recurrent Neural Networks (RNNs) and Transformers.

More specifically, audio embeddings are low dimensional vector representations mapped from the audio signal using techniques in machine learning, linear algebra and optimization. For example, audio embeddings can be created with a Transformer by passing the audio signal through a trained neural network and using the output from the last layer (output layer) of the neural network as the embeddings for that audio content. Such embeddings can capture long-range dependencies in the audio data, which is particularly useful for audio signals. During decoding, the audio decoder reconstructs audio waveforms from the latent embeddings, preserving fidelity and musical quality.

According to other aspects of the present disclosure, the annotated data set may also include audio-rating data, which is used to train the deep learning rating model. The prompt calibration process may include the user determining seed prompts and augmenting and expanding the seed prompts using a language model to determine the calibrated prompts.

### BRIEF DESCRIPTION OF THE DRAWING

FIG. 1 is an architecture and data flow diagram of a system and process in accordance with disclosed implementations.

### DETAILED DESCRIPTION

Disclosed implementations relate to an artificial intelligence (AI) content generation system that leverages human preference learning to enhance the quality and diversity of AI-generated content. The system includes a base generation model, a rating model, and a user interface, each element cooperating in the content generation process. Examples below are discussed in the context of music generation. However, one of skill in the art will recognize that the implementations can be applied to generation of any content, such as audio voice content, image content, 3D assets, and video content.

In disclosed implementations, the base generation model serves as the foundation for subsequent tasks. The base model utilizes large-scale audio datasets and employs a specialized architecture tailored to audio generation tasks. The architecture includes both autoregressive (AR) and non-autoregressive (NAR) methods in its neural network layers. The autoregressive (AR) method in the neural network layers of the base model operates by predicting the next audio token in the sequence based on previously generated tokens. In contrast, the non-autoregressive (NAR) method inference all/several tokens in parallel. The AR and NAR methods are combined to ensure coherence and fine-grained controllability of audio content generation.

The base model can also include a Unet-based or transformer-based audio latent diffusion model and a self-trained audio autoencoder model for audio encoding and decoding, enabling compression from waveform to latent space and reconstruction from latent embedding to waveform. As an example, the base model can be a well-known JEN-1 series model consisting of audio autoencoders and audio latent diffusion models. In the training process, the input of the audio latent diffusion model is the audio latent embedding, a timestep t, and the noise corresponding to the timestep t (the larger the timestep, the greater of the injected noise). The training goal is to predict the injected noise according to the timestep and the noisy latent (noise plus original latent). In the inference phase of the base model, the initial input of the audio latent diffusion model is a random Gaussian noise sampled from the normal distribution, its output is an denoised audio latent with the same shape. The denoising process follows a descending list of time steps, such as [1000, 900, . . . , 0], gradually predict the added noise, and remove the predicted noise from the current latent, to obtain the denoised input of the next step. Repeat this denoising step, and finally get a denoised latent, which is decoded to waveform by the audio decoder to complete the audio generation process.

The rating model is trained to evaluate the aesthetics of music using machine learning techniques. Training data for the rating model consists of music paired with rankings provided by professional musicians. Through conventional supervised learning techniques, the model learns human preferences and evaluation criteria, enabling it to rate music compositions. This methodology facilitates the utilization of diverse training datasets for a rating model. The audios generated by the base model are filtered using the rating model, with high-quality audios-that exceed a predetermined rating threshold being selected for subsequent fine-tuning of the base model.

The user interface allows human experts, such as professional musicians and composers, to edit the generated music and calibrate the corresponding prompts, aiming to achieve better alignment between music and user preferences. The editing can include editing to improve aesthetics, rhythm, genre, style and the like. Prompt calibration can include using seed prompts to generate augmented prompts based on a large language model (LLM). The calibrated prompts and edited high-quality samples can serve as new training data for the base model, enhancing the dataset's quality and improving model performance. The base model can be fine-tuned using the augmented data, further enhancing the quality of music generation and alignment with user preferences.

The fine-tuning process enhances the quality of music generation and alignment with user preferences by iteratively adjusting model parameters based on feedback from users. This iterative refinement allows the generative AI model to learn from user interactions and adapt its output to better match desired aesthetic criteria and stylistic preferences. By incorporating user feedback into the training process, the system can progressively improve its performance and generate music that resonates more closely with user expectations.

The interface can provide intuitive tools for editing generated music and refining corresponding prompts. Features of the interface can include:
Visualization of music compositions in various formats (e.g., sheet music, waveform displays) for easy editing and manipulation.
Interactive controls for adjusting musical elements such as genre, tempo, key, instrumentation, and arrangement.
Integration of feedback mechanisms to solicit input from users regarding their preferences and desired modifications.
Functionality for calibrating prompts by fine-tuning textual prompts to achieve desired musical outcomes.
Custom prompt upload and edit interface. And user interface for uploading and downloading edited audio.
   The interface allows experts to collaborate with the AI system effectively, facilitating iterative refinement and customization of music compositions.

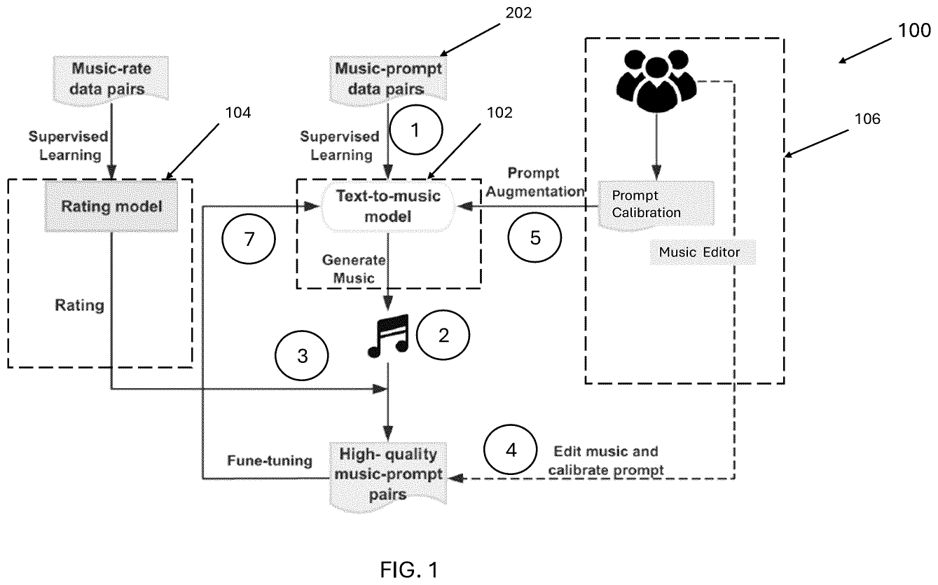

FIG. 1 illustrates architecture 100 and a configuration operation of a Generative AI system in accordance with disclosed implementations. The architecture includes base model 102 for generating music content based on a text prompt, Rating model 104 for rating and filtering music generated by base model 102 and user interface module 106 for allowing users/experts to edit generated music to improve the quality of the music and calibrate prompts to provide augmented/improved prompts. Base model 102 is initially trained with a training data set including many pairs of prompts and corresponding music clips. Rating model 104 is trained with a training data set including many pairs of music clips and corresponding ratings.

The configuration process starts at 1 where training data 202 (prompt/music clip pair) is used to initially train base model 102 through conventional supervised learning methods. At 2, music is generated by base model 102 and the music is rated and filtered by rating model 104, at 3. The resulting data, including data for high quality music and corresponding prompts, is then edited by experts, at 4, and prompts are calibrated/augmented, at 5, using interface module 106. At 7, the edited/calibrated data is used to fine tune base model 7, through supplemental training using the edited/calibrated data as part of augmented training data, for example. The process can be iterated until desired results are received and/or iterated periodically to accommodate changing styles and preferences.

This AI music generation system can be applied in various scenarios, including music composition, film scoring, and advertising music, among others. By directly learning from human preferences through the rating model and human feedback-driven interactive editing/calibration, AI-generated music will better conform to human aesthetic standards, enhancing efficiency and quality in music composition.

The AI music generation system may utilize large-scale music datasets during the training of the base text-to-music generation model. These datasets may encompass various styles and genres of music, along with corresponding tags. The use of such extensive and diverse datasets may ensure sufficient generalization capability for the generative AI base model. This means that the base model may be capable of generating music content that spans a wide range of styles and genres, thereby enhancing the diversity of the generated music.

It can be seen that the base model, the rating model, and the user interface module are interconnected. For instance, the base model may generate music content based on prompts, the rating model may evaluate and filter this content, and the user interaction interface may allow users to edit the content and provide calibrated prompts. These calibrated prompts may then be used to augment the training data for the base model, thereby enhancing the alignment of the generated music with user preferences.

The base model may be designed to generate content based on one or more prompts. The content generated by the base model may be music content, such as melodies, harmonies, rhythms, or any combination thereof. The base model may be capable of generating music content that spans a wide range of styles and genres, thereby enhancing the diversity of the generated music.

As noted above, the base model can be pretrained using an annotated data set comprising prompt-audio pairs. The prompt-audio pairs can include a prompt, such as a text description or a musical notation, and a corresponding audio clip. The audio clip can be a piece of music that matches the prompt. The base model can learn to generate music content that matches a given prompt by learning from the prompt-audio pairs in the annotated data set. The prompts can be converted to a vector prior to a training process using known algorithms such as Word2Vec.

The base model can be capable of generating music content based on multiple prompts. The prompts can be provided in a specific order, and the base model can generate music content that matches the sequence of prompts. This allows the base model to generate complex music content that evolves over time according to the sequence of prompts.

The specific architecture of the base model can be tailored to music generation tasks. This architecture can include a neural network that effects both autoregressive (AR) and non-autoregressive (NAR) methods in layers of the neural network. The AR and NAR methods may be used to enhance the quality and diversity of the generated music content.

The AR methods can be used in the neural network layers of the base model to generate music content based on previous outputs. The AR methods allow the base model to generate music content that is coherent and consistent over time, as each output is dependent on the previous outputs. This may be particularly useful for generating music content that has a consistent rhythm, melody, or harmony.

The NAR methods can be used in the neural network layers of the base model to generate music content independently of previous outputs. The NAR methods may allow the base model to generate music content that is diverse and unpredictable, as each output is generated independently of the previous outputs. This may be particularly useful for generating music content that is varied and diverse in terms of rhythm, melody, or harmony.

The use of both AR and NAR methods in the neural network layers of the base model allow the base model to generate music content that is both coherent and diverse. The AR methods may ensure that the generated music content is coherent and consistent over time, while the NAR methods may ensure that the generated music content is varied and diverse. This combination of AR and NAR methods enhances the quality and diversity of the generated music content.

The architecture of the base model can be configured to switch between AR and NAR methods depending on the specific requirements of the music generation task. For instance, the base model can use AR methods for generating music content that requires a consistent rhythm, melody, or harmony, and NAR methods for generating music content that requires variation and diversity in rhythm, melody, or harmony. This flexibility in the architecture of the base model enhances the adaptability of the base model to different music generation tasks.

As noted above, the base model can include a JEN-1 series model. The JEN-1 series model is a type of deep learning model that is specifically designed for audio processing tasks. The JEN-1 series model can include various components, such as audio autoencoders, that are configured to process audio data in various ways.

The JEN-1 series model may include audio autoencoders that are configured to compress audio data to a latent space and to reconstruct the compressed audio embedding back to the original audio. The audio autoencoders may include an audio encoder and a corresponding audio decoder. The audio encoder may be configured to compress the audio data to a latent space, and the audio decoder may be configured to reconstruct the compressed audio embedding back to the original audio. This process of compression and reconstruction allows the base model to handle large amounts of audio data efficiently, thereby enhancing the scalability of the base model.

The audio encoder may be a self-trained model that is trained to compress audio data to a latent space. The audio encoder can learn to compress audio data by learning from a large amount of audio data. The audio encoder can be capable of compressing audio data of various styles and genres, thereby enhancing the versatility of the base model.

The audio decoder can be a self-trained model that is trained to reconstruct compressed audio embeddings back to the original audio. The audio decoder can learn to reconstruct audio embeddings by learning from a large amount of audio data. The audio decoder can be capable of reconstructing audio embeddings of various styles and genres, thereby enhancing the versatility of the base model.

The rating model can be a separate component of the system, or it may be integrated with the base model. The rating model can be designed to evaluate the aesthetics of the generated music content, not just the technical quality. This may involve assessing various aspects of the music content, such as the melody, harmony, rhythm, tempo, dynamics, timbre, or any other musical characteristics. The rating model can assign a numerical rating to the music content based on its evaluation, with higher ratings indicating higher quality or more aesthetically pleasing music content.

The rating model can be trained using music paired with rankings provided by human experts, such as musicians and composers. The music may be a diverse collection of music pieces spanning various styles and genres, and the rankings may be numerical scores, or ordinal rankings assigned by the human musicians based on their subjective evaluation of the aesthetics of the music.

As noted above, the rating model can conduct filtering of the content generated by the base model based on the rating. The filtering may involve selecting music content that exceeds a predetermined rating threshold for further processing, such as fine-tuning of the base model or presentation to the user via the user interaction interface. The filtering may thus serve to ensure that the system focuses on high-quality music content that aligns with human aesthetic preferences.

The rating model can be configured to provide feedback to the base model based on the rating. The feedback may be used to adjust the hyperparameters of the base model during the fine-tuning process, thereby enhancing the alignment of the generated music content with human aesthetic preferences. The feedback can also be used to guide the generation of new music content by the base model to enhance the quality and diversity of the generated music content.

The rating model can be configured to learn and adapt over time. This can involve updating the parameters of the rating model based on new music-ranking pairs, thereby allowing the rating model to continuously improve its ability to evaluate the aesthetics of music. This may also involve adjusting the rating threshold based on the distribution of ratings for the generated music content, thereby allowing the system to adapt to changes in the quality or diversity of the generated music content.

The rating threshold used in the filtering process can be adjustable. For instance, the rating threshold can be increased to select a smaller subset of high-quality music content or decreased to select a larger subset of music content. The rating threshold may be adjusted based on various factors, such as the quality or diversity of the generated music content, the preferences of the user, or the requirements of the music generation task.

The filtering process conducted by the rating model can be performed in real-time or in batch mode. In real-time mode, the filtering process can be performed immediately after each piece of music content is generated by the base model. In batch mode, the filtering process can be performed after a batch of music content has been generated. The choice between real-time mode and batch mode may depend on various factors, such as the computational resources available, the volume of music content to be processed, or the requirements of the music generation task.

The user interface can be a graphical user interface, a command-line interface, a voice interface, or any other type of interface that allows users to interact with the system. The user interface can provide various tools or features for editing the generated music content, such as tools for adjusting the melody, harmony, rhythm, tempo, dynamics, timbre, or any other musical characteristics of the music content.

The prompt calibration process can involve the user determining seed prompts and augmenting and expanding the seed prompts using a language model or other methods to determine the calibrated prompts. The calibrated prompts may be more specific or detailed than the original seed prompts, thereby allowing the base model to generate music content that more closely aligns with the user's preferences. This can be achieved through various methods, including:
Utilizing large language models, such as ChatGPT for rewriting, expanding, and polishing seed text prompts.
Incorporating semantic or syntactic variations to diversify the content generated by the model.
Introducing random perturbations, deletion, masking, or modifications to the prompts to explore different creative possibilities.
   These techniques aim to broaden the scope of input prompts for the AI model, fostering creativity and adaptability in music generation.

The user interface may allow users to provide feedback on the generated music content. The feedback may be used to adjust the parameters of the base model during the fine-tuning process, thereby enhancing the alignment of the generated music content with user preferences. The feedback may also be used to guide the generation of new music content by the base model, thereby enhancing the quality and diversity of the generated music content.

The user interface may allow users to save or export the edited and calibrated music content. The saved or exported music content may be used as new training data for the base model, thereby enhancing the dataset's quality and improving model performance. The saved or exported music content may also be used for other purposes, such as music composition, film scoring, advertising music, or any other applications that require music content.

The seed prompts may be initial prompts provided by the user that describe various aspects of the desired music content, such as the style, genre, mood, tempo, or any other musical characteristics. The language model for expanding seed prompts can be trained on a large corpus of text data, allowing it to generate text that is grammatically correct and semantically coherent. The language model may generate text that describes additional or more specific aspects of the desired music content, thereby enhancing the specificity and detail of the prompts.

The calibration process conducted using the user interface can be performed in real-time or in batch mode. In real-time mode, the calibration process can be performed immediately after each piece of music content is generated by the base model. In batch mode, the calibration process can be performed after a batch of music content has been generated. The choice between real-time mode and batch mode may depend on various factors, such as the computational resources available, the volume of music content to be processed, or the requirements of the music generation task.

The disclosed multi-task learning optimizes both audio generation quality and alignment with prompts by jointly training the generative AI model on multiple related tasks (usually corresponding to multiple loss function designs). This approach enables the model to leverage shared representations and learn complementary aspects of music generation simultaneously. For example, the model may simultaneously optimize for musical coherence, emotional expression, and stylistic fidelity, leading to more holistic and nuanced outputs. By integrating diverse objectives into the learning process, multi-task learning enhances the robustness and versatility of the AI system, ultimately improving its ability to produce high-quality music aligned with user prompts/preference.

The invention has been described through disclosed implementations. One of skill in the art would readily recognize that the disclosed implementation can be modified in various way and be within the scope of the invention as defined by the appended claims.

1. A system for generating music using artificial intelligence, comprising:
a generative AI base model for generating content based on one or more prompts, the generative AI base model being pretrained using an annotated data set comprising prompt-audio pairs; a deep learning rating model configured to determine a rating of the quality of content generated by the generative AI base model and to conduct filtering of the content based on the rating; and
a user interface configured for users to edit specific content generated by the generative AI model and conduct a prompt calibration corresponding to the specific content including determining calibrated prompts corresponding to the specific content that are used to augment the training data for the generative AI base model.

2. The system of claim 1 wherein the generative AI base model is text-to-music generation model, and the content is music content, and wherein training data for the rating model consists of music paired with rankings, the rankings being provided by human musicians.

3. The system of claim 2, wherein the filtering comprises marking audio clips exceeding a predetermined rating threshold for subsequent fine-tuning of the generative AI base model.

4. The system of claim 3, wherein the text-to-music generation model includes a neural network that effects both autoregressive (AR) and non-autoregressive (NAR) methods in layers of the neural network.

5. The system of claim 2, wherein the text-to-music generation model includes a JEN-1 series model comprising:
audio autoencoders, the audio autoencoders including an audio encoder configured to compress the audio to a latent space and a corresponding audio decoder for reconstructing the latent embedding to the original audio, the model; and audio latent diffusion models.

6. The system of claim 1, wherein the annotated data set also includes audio-rating data, which is used to train the deep learning rating model.

7. The system of claim 1, wherein the calibration includes the user determining seed prompts and augmenting and expanding the seed prompts using a language model to determine the calibrated prompts.

8. A method for generating music using artificial intelligence, comprising:
generating, with a generative AI base model, content based on one or more prompts, the generative AI base model being pretrained using an annotated data set comprising prompt-audio pairs; determining, with a deep learning rating model, a rating of the quality of content generated by the generative AI base model and to conduct filtering of the content based on the rating; and presenting a user interface configured for users to edit specific content generated by the generative AI model and conduct a prompt calibration corresponding to the specific content including determining calibrated prompts corresponding to the specific content that are used to augment the training data for the generative AI base model.

9. The method of claim 8, wherein the generative AI base model is a text-to-music generation model, and the content is music content, and wherein training data for the rating model consists of music paired with rankings, the rankings being provided by human musicians.

10. The method of claim 9, wherein the filtering comprises marking audio clips exceeding a predetermined rating threshold for subsequent fine-tuning of the generative AI base model.

11. The method of claim 10, wherein the text-to-music generation model includes a neural network that effects both autoregressive (AR) and non-autoregressive (NAR) methods in layers of the neural network.

12. The method of claim 9, wherein the text-to-music generation model includes a JEN-1 series model comprising:
audio autoencoders, the audio autoencoders including an audio encoder configured to compress the audio to a latent space and a corresponding audio decoder for reconstructing the latent embedding to the original audio, the model; and audio latent diffusion models.

13. The method of claim 8, wherein the annotated data set also includes audio-rating data, which is used to train the deep learning rating model.

14. The method of claim 8, wherein the calibration includes the user determining seed prompts and augmenting and expanding the seed prompts using a language model to determine the calibrated prompts.
